(19) United States
(12) Patent Application Publication
(10) Pub. No.: US 2022/0100739 A1
(43) Pub. Date: Mar. 31, 2022

(54) DISTRIBUTED SEQUENTIAL TRANSACTIONAL DATABASE SELECTION

(71) Applicant: BRITISH TELECOMMUNICATIONS PUBLIC LIMITED COMPANY, LONDON (GB)

(72) Inventors: Jonathan ROSCOE, London (GB); Alexander HEALING, London (GB); Daniel JOSHUA, London (GB)

(21) Appl. No.: 17/593,622

(22) PCT Filed: Mar. 18, 2020
(86) PCT No.: PCT/EP2020/057538

§ 371 Date: Sep. 21, 2021

(30) Foreign Application Priority Data
Mar. 23, 2019 (EP) 19164776.7

(51) Int. Cl. G06F 16/23

(52) U.S. Cl. CPC G06F 16/2379

(57) ABSTRACT

A computer implemented method of provisioning a distributed sequential transactional database for a software application. The method includes receiving a descriptor for the application specifying characteristics of the database required for the application, accessing a registry of distributed sequential transactional databases and filtering the registry based on the descriptor to define a subset of databases, accessing each of at least some of the databases in the subset to verify an extent to which each accessed database complies with the characteristics in the descriptor, and associating a degree of compliance with each accessed database, such that databases in a subset of accessed databases having a degree of compliance meeting a threshold degree of compliance are determined to be compliant databases, and ranking the compliant databases in terms of the degree of compliance to select a database for access by the application.

### PRIORITY CLAIM

The present application is a National Phase entry of PCT Application No. PCT/EP2020/057538, filed Mar. 18, 2020, which claims priority from EP Patent Application No. 19164776.7, filed Mar. 23, 2019, which is hereby fully incorporated herein by reference.

### TECHNICAL FIELD

The present disclosure relates to the selection of distributed sequential transactional databases for software applications.

### BACKGROUND

Distributed sequential transactional databases such as blockchain databases are often increasingly employed by a wide and diverse variety of applications ranging from cryptocurrencies, authentication, asset management, interoperation and recording of data by internet-of-things (IoT) devices, and other applications known in the art. Each database can be configured differently according to characteristics including algorithms used, security features, peer-mining characteristics, database size and age, reliability, security, and other characteristics. Typically, a database is used by a particular application based on availability, familiarity or a bespoke or new database is generated. The features of such databases may not reflect the requirements of the particular application. Furthermore, features available in other databases may be underutilized or not put to best effect.

Thus, it would be beneficial to provision distributed sequential transactional databases for applications without the aforementioned disadvantages.

### SUMMARY

According to a first aspect of the present disclosure, there is a provided a computer implemented method of provisioning a distributed sequential transactional database for a software application. The method includes receiving a descriptor for the application specifying characteristics of the database required for the application, accessing a registry of distributed sequential transactional databases and filtering the registry based on the descriptor to define a subset of databases, accessing each of at least some of the databases in the subset to verify an extent to which each accessed database complies with the characteristics in the descriptor, and associating a degree of compliance with each accessed database, such that databases in a subset of accessed databases having a degree of compliance meeting a threshold degree of compliance are determined to be compliant databases, and ranking the compliant databases in terms of the degree of compliance to select a database for access by the application.

In embodiments, at least some of the distributed sequential transactional databases are blockchains.

In embodiments, the characteristics of a database include one or more of: an algorithm used to validate a proof-of-work of a miner for the database, a format and/or length of an address used for entities transacting in the database, a number of peers in a miner network for the database, a characteristic of a genesis block of the database, a hashpower of the database, a consensus mechanism used for the database, a maximum block time and/or size for the database, an age of the database, a size of the database, a number of blocks of the database, an encryption algorithm or standard used for the database, a peer latency for the database, a transaction security protocol or standard for the database, and a description of the database.

In embodiments, selecting a database for access by the application includes providing the application with a software interface or connector for accessing the selected database.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is an arrangement for provisioning a distributed sequential transactional database for an application according to embodiments of the present disclosure.

FIG. 3 is a flowchart of a method for provisioning a distributed sequential transactional database for an application according to embodiments of the present disclosure.

### DETAILED DESCRIPTION

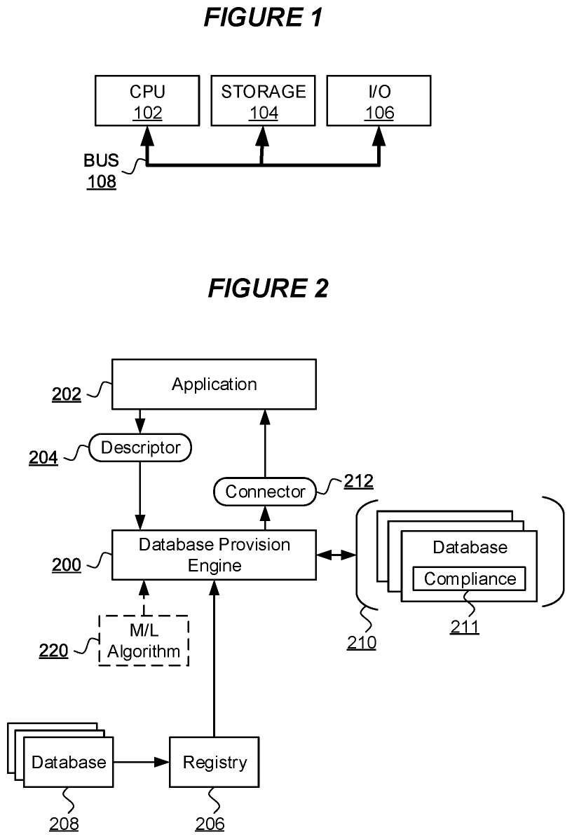

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present disclosure select and provision a distributed sequential transactional database for a software application 202. A distributed sequential transactional database is a transactional data store that may be distributed and shared by multiple entities via a communication network. Distributed sequential transactional databases are well known in the field of cryptocurrencies and are documented, for example, in “Mastering Bitcoin. Unlocking Digital Crypto-Currencies.” (Andreas M. Antonopoulos, O'Reilly Media, April 2014). Thus, an example of such a database is a blockchain database though it will be appreciated that other suitable databases, data structures or mechanisms possessing the characteristics essential for embodiments of the present disclosure could alternatively be used. Typically, a blockchain database is a distributed chain of block data structures accessed by a network of nodes, often referred to as a network of miners. Each block in a blockchain includes a one or more data structures, and in some exemplary blockchains a Merkle tree of hash or digest values for transactions included in a block are used to arrive at a hash value for a block which is itself combined with a hash value for a preceding block to generate a chain of blocks (i.e. a blockchain). A new block of one or more transactions is added to the blockchain by such miner software, hardware, firmware, or combination systems in, for example, a miner network. A newly added block constitutes a current state of the blockchain. Such miners undertake validation of substantive content of transactions (such as any criteria defined therein) and adds a block of one or more new transactions to a blockchain as a new blockchain state when a challenge is satisfied as a “proof-of-work”, typically such challenge involving a combination hash or digest for a prospective new block and a preceding block in the blockchain and some challenge criterion. Thus, miners in a miner network may each generate prospective new blocks for addition to the blockchain. Where a miner satisfies or solves a challenge and validates the transactions in a prospective new block such new block is added to the blockchain. Accordingly, a blockchain provides a distributed mechanism for reliably verifying a data entity such as an entity constituting or representing the potential to consume a resource.

FIG. 2 is an arrangement for provisioning a distributed sequential transactional database for an application 202 according to embodiments of the present disclosure. The application includes, but is not necessarily exclusively, a software component desirous or requiring access to and/or services of a distributed sequential transactional database such as a blockchain database. The application generates, provides and/or communicates a descriptor 204 as a data structure, file or data stream. The descriptor 204 includes a specification of characteristics of a database required by the application 202 for its operation. Such characteristics can include one or more of, inter alia: an algorithm used to validate a proof-of-work of a miner for the database; a format and/or length of an address used for entities transacting in the database; a number of peers in a miner network for the database; a characteristic of a genesis block of the database; a hashpower of the database; a consensus mechanism used for the database; a maximum block time and/or size for the database; an age of the database; a size of the database; a number of blocks of the database; an encryption algorithm or standard used for the database; a peer latency for the database; a transaction security protocol or standard for the database; a description of the database; and/or other characteristics of a distributed sequential transactional database as will be apparent to those skilled in the art.

A database provision engine 200 is a hardware, software, firmware or combination component operable to select and provision a database for the application 202 as described below. The engine 200 receives or accesses the descriptor 204 for the application 202. Also accessible to the engine 200 is a registry 206 as a list, database, data structure or other suitable means for identifying a set of distributed sequential transactional databases 208 that may be candidates for use by the application 202. The registry 206 includes or references characteristic information for each database 208 in the set such that the engine 200 can make a comparison between the characteristics in the descriptor 204 and the characteristics of each database 208. The engine 200 initially filters the set of databases 208 by comparing the characteristics for each database 208 with those specified in the descriptor 204. Subsequently, the engine 200 performs a verification of characteristics specified in the descriptor 204 by accessing each database in the filtered set of databases. The access to databases by the engine 200 is intended to verify (or not) at least a subset of the characteristics in the descriptor 204 so as to determine a degree or extent of compliance of each database in the filtered set with the requirements in the descriptor 204. Thus, in this way, a set of compliant databases for which at least some of the characteristic requirements specified in the descriptor 204 are satisfied is defined. Each database in the set of compliant databases is associated with a degree of compliance determined by the engine 200 based on an extent to which the database is compliant with the characteristics. For example, one or more states of partial compliance, such as compliance with only a subset of the characteristics, can be reflected by way of the degree of compliance.

Thus, the engine 200 defines a set 210 of compliant databases each having associated a degree of compliance 211. The database subsequently ranks the databases in the compliant database set 210 based on the degree of compliance to select a most-fit, top-ranked or most suitable database form the set for provisioning to the application 202. The selected database can be provisioned for the application 202 by providing the application 202 with an interface, connector, reference, address or other suitable access means such that the application 202 can access the selected database.

In one embodiment, the selection of a database for the application 202 is further dependent on a machine learning algorithm 220 such as an autoencoder trained to categorize characteristics of a database as viable or non-viable with the characteristics of a descriptor 204. Thus, such a machine learning algorithm 220 can be trained on the basis of training data for representative application descriptors and/or characteristics for applications and characteristics of databases. The categorization of the machine learning algorithm 220 can be based on supervised training in which the ongoing viability of a database for an application descriptor 204 or characteristics is encoded by the algorithm 220 through, for example, backpropagation, so as to provide an indication of suitability of a database by way of categorization by the algorithm 220.

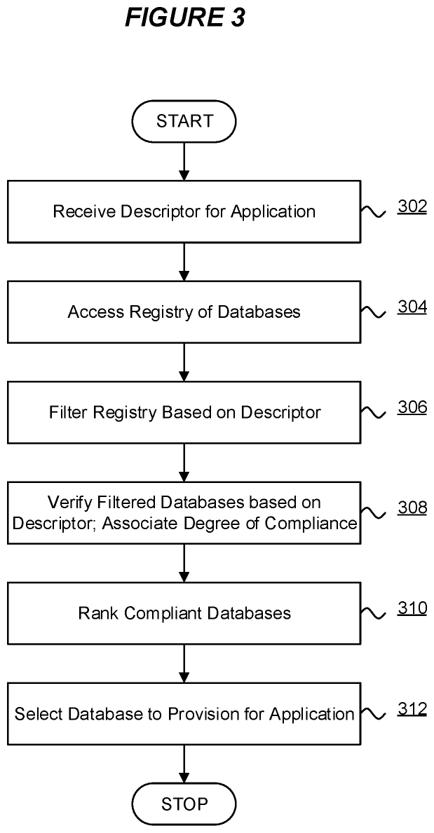

FIG. 3 is a flowchart of a method for provisioning a distributed sequential transactional database for an application 202 according to embodiments of the present disclosure. Initially, at 302, the method receives a descriptor 204 for an application 202 specifying characteristics of a database required for the application 202. Subsequently, at 304 the method accesses a registry 206 of distributed sequential transactional databases 208. At 306 the method filters the databases 208 in the registry 206 based on the characteristics in the descriptor 204 and the characteristics of each database. The characteristics of each database can be stored in, or referenced by the registry 206. At 308 the method verifies each of the databases in the filtered set of databases for a degree of compliance with the descriptor 204 and associates each database with its respective degree of compliance to form a set of compliant databases 210. At 310 the compliant databases are ranked based on the degree of compliance 211 and, at 312, a database is selected for provisioning for the application 202 based on the ranking.

Insofar as embodiments of the present disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the present disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of provisioning a distributed sequential transactional database for a software application comprising:
receiving a descriptor for the software application specifying characteristics of the distributed sequential transactional database required for the software application;
accessing a registry of distributed sequential transactional databases and filtering the registry based on the descriptor to define a subset of distributed sequential transactional databases;
accessing each of at least some of the distributed sequential transactional databases in the subset to verify an extent to which each accessed database complies with the characteristics in the descriptor, and associating a degree of compliance with each accessed database, such that distributed sequential transactional databases in a subset of accessed databases having a degree of compliance meeting a threshold degree of compliance are determined to be compliant databases;
ranking the compliant databases in terms of the degree of compliance to select a distributed sequential transactional database for access by the application.

2. The method of claim 1 wherein at least some of the distributed sequential transactional databases are blockchains.

3. The method of claim 1 wherein the characteristics of a distributed sequential transactional database include one or more of: an algorithm used to validate a proof-of-work of a miner for the distributed sequential transactional database; a format and/or length of an address used for entities transacting in the distributed sequential transactional database; a number of peers in a miner network for the distributed sequential transactional database; a characteristic of a genesis block of the distributed sequential transactional database; a hashpower of the distributed sequential transactional database; a consensus mechanism used for the distributed sequential transactional database; a maximum block time and/or size for the distributed sequential transactional database; an age of the distributed sequential transactional database; a size of the distributed sequential transactional database; a number of blocks of the distributed sequential transactional database; an encryption algorithm or standard used for the distributed sequential transactional database; a peer latency for the distributed sequential transactional database; a transaction security protocol or standard for the distributed sequential transactional database; and a description of the distributed sequential transactional database.

4. The method of claim 1 wherein selecting a distributed sequential transactional database for access by the software application includes providing the software application with a software interface or connector for accessing the selected distributed sequential transactional database.

5. A computer system including a processor and memory storing computer program code for performing the method of claim 1.

6. A computer program element comprising computer program code to, when loaded into a computer system and executed thereon, cause the computer to perform the method of claim 1.
